(19) United States
(12) Patent Application Publication
(10) Pub. No.: US 2023/0121149 A1
(43) Pub. Date: Apr. 20, 2023

(54) PORTABLE ILLUMINATION DEVICE

(71) Applicants: Joseph Muszik, Cleburne, TX (US); Kristi L. Muszik, Cleburne, TX (US)

(72) Inventors: Joseph Muszik, Cleburne, TX (US); Kristi L. Muszik, Cleburne, TX (US)

(21) Appl. No.: 17/504,035

(22) Filed: Oct. 18, 2021

(51) Int. Cl. F21V 23/04; H05B 47/12; F21V 14/02

(52) U.S. Cl. CPC F21V 23/0471; F21V 23/0414; H05B 47/12; F21V 14/025

(57) ABSTRACT

A portable illumination device, including a main body, an illumination unit movably disposed on at least a portion of the main body to emit a beam of light and illuminate a surrounding area, at least one sensor disposed on at least a portion of the main body to turn on the illumination unit in response to detecting an external condition, and a surface fastener disposed on at least a portion of the main body to removably connect the main body to an external surface.

### BACKGROUND

### 1. Field

The present general inventive concept relates generally to an illumination device, and particularly, to a portable illumination device.

### 2. Description of the Related Art

The sense of sight is one of the most important senses that allows a person and/or an animal to view a surrounding environment. Moreover, the sense of sight typically relies on the ability of at least one eye to receive light. The light entering the at least one eye allows the surrounding environment and/or any objects to be identified. However, in most cases, the person and/or the animal can be helpless and vulnerable in dark and/or low light conditions. Also, the dark and/or light conditions makes it challenging to locate, assess, and/or navigate an area effectively.

Flashlights are portable devices that allow the person and/or the animal to create light at any desired location. Unfortunately, flashlights rely on being carried by a user. Security lights are other types of lights designed for safety and to improve visibility in the surrounding environment. Yet, security lights are stationary and attached to buildings.

Therefore, there is a portable illumination device that can quickly provide a light source, as well as, have motion sensing capabilities and is attachable to any surface.

### SUMMARY

The present general inventive concept provides a portable illumination device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable illumination device, including a main body, an illumination unit movably disposed on at least a portion of the main body to emit a beam of light and illuminate a surrounding area, at least one sensor disposed on at least a portion of the main body to turn on the illumination unit in response to detecting an external condition, and a surface fastener disposed on at least a portion of the main body to removably connect the main body to an external surface.

The illumination unit may include a motor connected to the illumination unit to move the illumination unit in response to rotation of the motor.

The portable illumination device may further include a processing unit disposed within at least a portion of the main body and connected to the illumination unit to command the motor to move the illumination unit based on a position of at least one of an object, a person, and an animal that has been detected by the at least one sensor as being within the beam of light of the illumination unit, such that the illumination unit follows at least one of the object, the person, and the animal.

The portable illumination device may further include an alarm unit disposed on at least a portion of the main body to emit at least one sound in response to the at least one sensor detecting the external condition.

The portable illumination device may further include an intensity adjustment switch movably disposed on at least a portion of the main body to adjust an intensity level of the beam of light emitted from the illumination unit.

The at least one sensor may detect the external condition as being at least one of motion, a change in a temperature level, and a change in a sound level.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top perspective view of a portable illumination device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Portable Illumination Device 100
Main Body 110
Illumination Unit 120
Motor 121
Sensor 130
Processing Unit 140
Alarm Unit 150
Intensity Adjustment Switch 160
Alarm Power Button 170
Illumination Power Button 180
Power Source 190
Surface Fastener 200

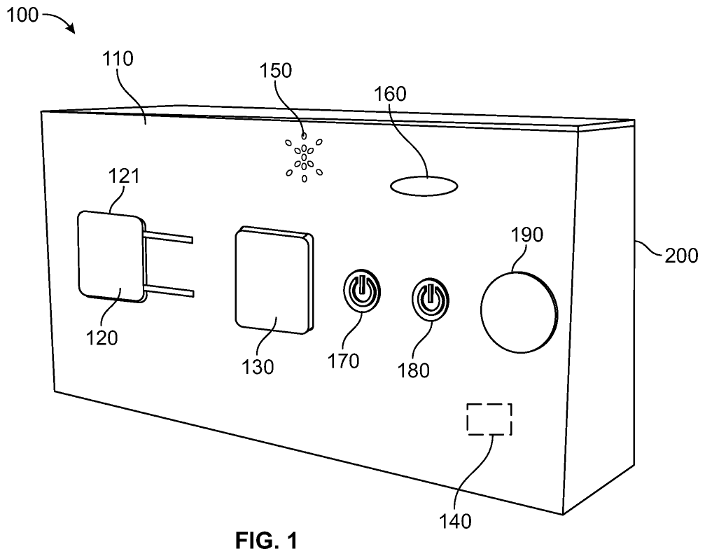

FIG. 1 illustrates a top perspective view of a portable illumination device 100, according to an exemplary embodiment of the present general inventive concept.

The portable illumination device 100 may be constructed from at least one of metal, plastic, wood, glass, and rubber, etc., but is not limited thereto.

The portable illumination device 100 may include a main body 110, an illumination unit 120, at least one sensor 130, a processing unit 140, an alarm unit 150, an intensity adjustment switch 160, an alarm power button 170, an illumination power button 180, a power source 190, and a surface fastener 200, but is not limited thereto.

Referring to FIG. 1, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto.

The main body 110 may be opaque and/or transparent. For example, a first side and/or a first end of the main body 110 may be opaque and a second side and/or a second end of the main body 110 may be transparent. In other words, the second side and/or the second end of the main body 110 may facilitate viewing therein to determine a malfunction of at least one component within the main body 110.

The illumination unit 120 may be constructed as a light using an incandescent bulb, a fluorescent bulb, and a light-emitting diode (LED), but is not limited thereto.

The illumination unit 120 may include a motor 121, but is not limited thereto.

The illumination unit 120 may be movably (i.e., pivot, rotate) disposed on at least a portion of a top side of the main body 110. More specifically, the illumination unit 120 may pivot within the main body 110, such that the illumination unit 120 may be oriented toward any side perpendicular with respect to a side where the illumination unit 120 is disposed. Moreover, the illumination unit 120 may at least partially illuminate a surrounding area of the main body 110 and/or emit a beam of light in at least one direction away from the illumination unit 120.

The motor 121 may be disposed within at least a portion of the main body 110 and/or connected to the illumination unit 120.

The at least one sensor 130 may include a motion sensor, a temperature sensor, and a sound sensor, but is not limited thereto.

The at least one sensor 130 may be disposed on at least a portion of the main body 110. The at least one sensor 130 may respond to an external condition, such that the at least one sensor 130 may detect motion within a predetermined distance away from the at least one sensor 130. For example, the at least one sensor 130 may detection motion within five feet, ten feet, and/or twenty feet. Accordingly, the illumination unit 120 may illuminate in response to the at least one sensor 130 detecting motion within the predetermined distance.

Alternatively, the at least one sensor 130 may respond to the external condition, such that the at least one sensor 130 may detect a change in a temperature level within the predetermined distance away from the at least one sensor 130. For example, the at least one sensor 130 may compare an increase in the temperature level to a predetermined normal temperature level of a person (e.g., ninety-seven degrees Fahrenheit to ninety-nine degrees Fahrenheit). Accordingly, the illumination unit 120 may illuminate in response to the at least one sensor 130 detecting the change in the temperature level within the predetermined distance.

Alternatively, the at least one sensor 130 may respond to the external condition, such that the at least one sensor 130 may detect a change in a sound level within the predetermined distance away from the at least one sensor 130. For example, the at least one sensor 130 may compare an increase in the sound level to an absence of sound, such that a presence of sound indicates a presence of a person and/or an animal, whereas absence indicates a lack of the presence of the person and/or the animal. Accordingly, the illumination unit 120 may illuminate in response to the at least one sensor 130 detecting the change in the sound level within the predetermined distance.

Furthermore, the illumination unit 120 may adjust a color based on the at least one sensor 130 detecting motion, the change in the temperature level, and/or the change in the sound level. For example, the at least one sensor 130 detecting motion may illuminate white, the at least one sensor 130 detecting the change in the temperature level may illuminate blue, and/or the at least one sensor 130 detecting the change in the sound level may illuminate red.

The processing unit 140 (or central processing unit, CPU) may include electronic circuitry to carry out instructions of a computer program by performing basic arithmetic, logical, control and input/output (I/O) operations specified by the instructions. The processing unit 140 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 140 may also include a microprocessor and a microcontroller.

The processing unit 140 may be disposed within at least a portion of the main body 110 and/or connected to the illumination unit 120 and/or the at least one sensor 130. The processing unit 140 may have a program running thereon to control the illumination unit 120. More specifically, the illumination unit 120 may lock on to (i.e., follows, tracks) an object, a person, and/or an animal in response to illuminating the beam of light on the object, the person, and/or the animal for a predetermined period of time (e.g., five seconds, ten seconds, twenty seconds, etc.). For example, the illumination unit 120 may remain directed toward the object, the person, and/or the animal after turning on the illumination unit 120 and/or having the illumination unit 120 locked on the object, the person, and/or the animal, such that the at least one sensor 130 detects the object, the person, and/or the animal at an end of the beam of light. In other words, the illumination unit 120 may move in response to rotation of the motor 121 to change a position of the illumination unit 120 based on a command of the processing unit 140. As such, the processing unit 140 may assist a user to locate the object, the person, and/or the animal. Also, the processing unit 140 may assist the user to identify a position within a dark and/or a low light environment.

The alarm unit 150 may include a speaker and/or a display unit (e.g., a screen), but is not limited thereto.

The alarm unit 150 may be disposed on at least a portion of the main body 110. The alarm unit 150 may emit at least one sound (e.g., a beep, a cricket chirp) in response to the at least one sensor 130 detecting motion, the change in the temperature level, and/or the change in the sound level. As such, the alarm unit 150 may alert the user based on the at least one sensor 130 detecting motion, the change in the temperature level, and/or the change in the sound level.

The intensity adjustment switch 160 may be movably (e.g., pivotally) disposed on at least a portion of the main body 110. The intensity adjustment switch 160 may be moved in a first lateral direction or a second lateral direction opposite with respect to the first lateral direction. Additionally, the intensity adjustment switch 160 may adjust an intensity level of the beam of light emitted from the illumination unit 120. For example, the intensity adjustment switch 160 may increase (i.e., expand) a width of the beam of light in response to moving in the first lateral direction and decrease (i.e., narrow) the width of the beam of light in response to moving in the second lateral direction. As such, the illumination unit 120 may illuminate a large area and/or focus on a smaller area (e.g., a point) based on a setting of the intensity adjustment switch 160.

The alarm power button 170 may be disposed on at least a portion of the main body 110. The alarm power button 170 may turn on the alarm unit 150 in response to depressing the alarm power button 170 a first time. The alarm power button 170 may turn off the alarm unit 150 in response to depressing the alarm power button 170 a second time.

The illumination power button 180 may be disposed on at least a portion of the main body 110. The illumination power button 180 may turn on the illumination unit 120 in response to depressing the illumination power button 180 a first time. The illumination power button 170 may turn off the illumination unit 120 in response to depressing the illumination power button 170 a second time. Furthermore, the illumination power button 180 may set the illumination unit 120 to automatically turn off after a first period of time (e.g., thirty minutes) in response to depressing the illumination power button 180 for a first predetermined period of time (e.g., five seconds). The illumination power button 180 may set the illumination unit 120 to automatically turn off after a second period of time (e.g., sixty minutes) in response to depressing the illumination power button 180 for a second predetermined period of time (e.g., ten seconds). Finally, the illumination power button 180 may set the illumination unit 120 to automatically turn off after a third period of time (e.g., ninety minutes) in response to depressing the illumination power button 180 for a third predetermined period of time (e.g., fifteen seconds).

The power source 190 may include a battery and a solar cell, but is not limited thereto.

The power source 190 may be disposed within at least a portion of the main body 110. The power source 190 may provide power to the illumination unit 120, the at least one sensor 130, the processing unit 140, the alarm unit 150, the intensity adjustment switch 160, the alarm power button 170, and/or the illumination power button 180.

The surface fastener 200 may include an adhesive (e.g., tape, glue), a magnet, a cord, a wire, a bolt, a nut, a nail, a washer, and/or any combination thereof, but is not limited thereto.

The surface fastener 200 may be disposed on at least a portion of a bottom side of the main body 110 opposite with respect to the top side. The surface fastener 200 may removably connect the main body 110 to an external surface, such as a wall and/or a ceiling. As such, the surface fastener 200 may connect the main body 110 to the external surface, such that the user may keep hands free. However, the main body 110 may easily fit within at least one hand of the user during transport. Furthermore, the surface fastener 200 may prevent the main body 110 from moving away (i.e., falling off) from the external surface while connected to the external surface.

Therefore, the portable illumination device 100 may provide a light source that does not require being carried by the user. Also, the portable illumination device 100 may illuminate a surrounding environment in response to the external condition.

The present general inventive concept may include a portable illumination device 100, including a main body 110, an illumination unit 120 movably disposed on at least a portion of the main body 110 to emit a beam of light and illuminate a surrounding area, at least one sensor 130 disposed on at least a portion of the main body 110 to turn on the illumination unit 120 in response to detecting an external condition, and a surface fastener 200 disposed on at least a portion of the main body 110 to removably connect the main body 110 to an external surface.

The illumination unit 120 may include a motor 121 connected to the illumination unit 120 to move the illumination unit 120 in response to rotation of the motor 121.

The portable illumination device 100 may further include a processing unit 140 disposed within at least a portion of the main body 110 and connected to the illumination unit 120 to command the motor 121 to move the illumination unit 120 based on a position of at least one of an object, a person, and an animal that has been detected by the at least one sensor 130 as being within the beam of light of the illumination unit 120, such that the illumination unit 120 follows at least one of the object, the person, and the animal.

The portable illumination device 100 may further include an alarm unit 150 disposed on at least a portion of the main body 110 to emit at least one sound in response to the at least one sensor 130 detecting the external condition.

The portable illumination device 100 may further include an intensity adjustment switch 160 movably disposed on at least a portion of the main body 110 to adjust an intensity level of the beam of light emitted from the illumination unit 120.

The at least one sensor 130 may detect the external condition as being at least one of motion, a change in a temperature level, and a change in a sound level.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A portable illumination device, comprising:
a main body;
an illumination unit movably disposed on at least a portion of the main body to emit a beam of light and illuminate a surrounding area, such that the illumination unit moves within the main body, such that the illumination unit is disposed within an interior of the main body and surrounded by the main body on a first side, a second side, a third side, a fourth side, and a fifth side of the illumination unit, such that a sixth side of the main body is at least partially exposed to an exterior of the main body;
at least one sensor disposed on at least a portion of the main body to turn on the illumination unit in response to detecting an external condition; and
a surface fastener disposed on at least a portion of the main body to removably connect the main body to an external surface.

2. The portable illumination device of claim 1, wherein the illumination unit comprises:
a motor connected to the illumination unit to move the illumination unit in response to rotation of the motor.

3. The portable illumination device of claim 2, further comprising:
a processing unit disposed within at least a portion of the main body and connected to the illumination unit to command the motor to move the illumination unit based on a position of at least one of an object, a person, and an animal that has been detected by the at least one sensor as being within the beam of light of the illumination unit, such that the illumination unit follows at least one of the object, the person, and the animal.

4. The portable illumination device of claim 1, further comprising:
an alarm unit disposed on at least a portion of the main body to emit at least one sound in response to the at least one sensor detecting the external condition.

5. The portable illumination device of claim 1, further comprising:
an intensity adjustment switch movably disposed on at least a portion of the main body to adjust an intensity level of the beam of light emitted from the illumination unit.

6. The portable illumination device of claim 1, wherein the at least one sensor detects the external condition as being at least one of motion, a change in a temperature level, and a change in a sound level.

7. A portable illumination device, comprising:
a main body;
an illumination unit movably disposed on at least a portion of the main body to emit a beam of light and illuminate a surrounding area, such that the illumination unit is disposed within an interior of the main body and surrounded by the main body on a first side, a second side, a third side, a fourth side, and a fifth side of the illumination unit, such that a sixth side of the main body is at least partially exposed to an exterior of the main body;
at least one sensor disposed on at least a portion of the main body to turn on the illumination unit in response to detecting an external condition;
an illumination power button disposed on at least a portion of the main body to set the illumination unit to automatically turn off after at least one period of time in response to being depressed for at least one of a first predetermined period of time, a second predetermined period of time, and a third predetermined period of time; and
a surface fastener disposed on at least a portion of the main body to removably connect the main body to an external surface.
